(19) United States
(12) Patent Application Publication
(10) Pub. No.: US 2004/0013237 A1
(43) Pub. Date: Jan. 22, 2004

(54) Radiotherapy apparatus and collimator set therefor

(76) Inventors: Kevin John Brown, West Sussex (GB); Ralph Peter Streamer, West Sussex (GB)

Correspondence Address: BROMBERG & SUNSTEIN LLP, 125 SUMMER STREET, BOSTON, MA, 02110-1618, US

(21) Appl. No.: 10/399,064

(22) PCT Filed: Sep. 19, 2001
(86) PCT No.: PCT/GB01/04176

(30) Foreign Application Priority Data
Oct. 11, 2000 (GB) 0024843.5

(51) Int. Cl. G21K 1/02

(52) U.S. Cl. 378/147

(57) ABSTRACT

A collimator set for a radiotherapy apparatus comprises, in sequence, an aperture collimator, a multi-leaf collimator with a pair of opposing arrays of elongate leaves each moveable longitudinally in a Y direction, and a leaf edge collimator, the aperture collimator being adapted to collimate the beam in the X and Y direction to a first extent, and the leaf edge collimator being adapted to further collimate the extent of the beam in the Y direction to a second and therefore lesser extend. This means that to close a pair of opposing leaves, they are moved to their minimum separation, with the gap being convered by the leaf edge collimator. The MLC is after the aperture collimator, so in combination with thin leaves, the MLC leaves will project a much reduced leaf width at the isocentre of the radiotherapy apparatus and collimation of the radiation field by fractional leaf widths becomes unnecessary. A radiotherapy apparatus comprising a collimator set as defined above is also disclosed.

### FIELD OF THE INVENTION

The present invention relates to a radiotherapy apparatus, in particular to the arrangement of collimators within the radiation head.

### BACKGROUND ART

In a conventional multi-leaf collimator (MLC), the radiation beam is collimated by an array of thin leaves lying alongside each other which can each be extended longitudinally to define a unique edge. The leaves move in a given direction (Y) and generally there are two sets of additional backup diaphragms orthogonal to this (X). These are solid and move in and out in the X and Y directions. They perform two functions. The X diaphragm allows the field edge to be adjusted in a continuous manner, whereas the leaves alone would only allow discrete adjustments a leaf width at a time. The Y diaphragm reduces the effect of leakage through the leaves. The X diaphragm also shields the gap between leaves that are out of the treatment field and are effectively ‘closed’.

This arrangement is shown in FIG. 1. An X-ray source 10 is placed behind a primary collimator 12 which allows through a divergent cone of radiation 14. The beam is modified by a combination of a filter, an ion chamber and a wedge 16 before passing through a mirror 18 placed at an angle to the beam axis. This provides a view down the beam for a camera located at 20. Thus, the camera is able to see the position of the subsequent collimators for checking purposes.

After the mirror 18, the beam is modulated by a multi-leaf collimator (MLC) 22 formed of arrays of opposing leaves 24,26. These can move longitudinally in a Y direction from left to right in FIG. 1 as shown by arrows 28. A large number of narrow leaves forms an array stretching into and out of the figure. Thus, by moving each leaf to a desired position, the array forms a collective edge which collimates the beam.

Subsequent to the MLC 22 is a Y collimator. This consists of a pair of jaws 32, 34 which each extend across the width of the multi-leaf array 22 and can be moved in and out in the same Y direction as the leaves 24, 26 of the MLC array 22. These leaves therefore lie behind the leaves of the MLC 22 and limit leakage of radiation between the individual leaves.

Finally, an X collimator 36 comprises a pair of jaws similar to those of the Y collimator but deeper and displaced by 90°. One such jaw 38 is visible in FIG. 1. The jaws of the X collimators move transversely to the leaves of the MLC 22. To avoid collisions between opposing leaves in the MLC array 22, a minimum approach distance is defined which provides a minimum gap between leaves in the Y direction. This however creates a gap in the collimation. To cover this, the leaves are positioned so that this gap lies remote from the treatment area, and the relevant X collimator jaw is advanced to cover it. The X collimator can also trim th radiation field in the X direction by fractional leaf widths. The jaws are deeper since they must in places provide full attenuation of the beam, as opposed to the Y collimator which provides a secondary attenuation after the MLC 22.

These moving diaphragms together with their corresponding b arings and readout systems introduce significant complexity into the design and xtend the depth of the apparatus, reducing the clearance between it and the patient. The present invention seeks to address these issues.

### SUMMARY OF THE INVENTION

The present invention therefore provides a collimator set for a radiotherapy apparatus comprising, in sequence, an aperture collimator, a multi-leaf collimator with a pair of opposing arrays of elongate leaves each moveable longitudinally in a Y direction, the aperture collimator being adapted to collimate the beam in the Y direction to a first extent.

It is preferred that a leaf edge collimator is provided, adapted to further collimate the extent of the beam in the Y direction to a second and therefore lesser extent.

This means that to close a pair of opposing leaves, they are moved to their minimum separation, with the gap being covered by the leaf edge collimator. Thus the former X collimator is unnecessary.

In this arrangement, the MLC is after the aperture collimator. In combination with thin leaves, the MLC leaves will project a much reduced leaf width at the isocentre of the radiotherapy apparatus. As a result, collimation of the radiation field by fractional leaf widths becomes unnecessary. Such leaves can also be focussed at a point slightly offset relative to the target, thereby reducing leakage between leaves to a clinically acceptable level and removing the need for the former Y collimator.

The aperture collimator is preferably fixed, as is the leaf edge collimator. This will mean that the complexity of a moveable collimator with its associated bearings, drive mechanism etc will have be n removed. The aperture collimator can act in the X direction also, and in practice this will usually be the case.

The aperture collimator could be integrated into the primary collimators, filters etc, but need not be. In practice it is likely to be more practical to provide a fresh collimator set that can be employed with existing sources. These will often include a primary collimator, filter, camera etc.

The projected difference in the Y direction between the first and second extent is preferably not less than the projected minimum approach of opposing leaves of the MLC array. This ensures adequate cover for the opposing leaf gap by the leaf edge collimator. Preferably the projected difference is more than twice or more than three times the projected minimum approach, to allow for positioning tolerances.

The present invention also relates to a radiotherapy apparatus comprising a collimator set as defined above.

### BRIEF DESCRIPTION OF DRAWINGS

An embodiment of the present invention will now be described by way of example, with reference to the following figures, in which;

FIG. 1, already described, shows a vertical section through a conventional radiation head with collimators;

FIG. 2 shows a corresponding view of a radiation head according to the present invention; and

FIG. 3 shows a view from beneath of the radiation head of FIG. 2.

### DETAILED DESCRIPTION OF THE EXAMPLE

Referring to FIG. 2, the present invention provides a simplified method of using an MLC by replacing the moving X and Y diaphragms with fixed diaphragms before and after the MLC, as shown in FIG. 2. It also maintains the conventional configuration of primary collimator, filter and ion chamber.

Thus, a radiation source 10 emits x-rays which are limited to a divergent beam 14 by a primary collimator 12 and adjusted by a filter, ion chamber and wedge 16. A fixed aperture collimator 50 then collimates the beam to an intermediate field size 52 in the X and Y directions.

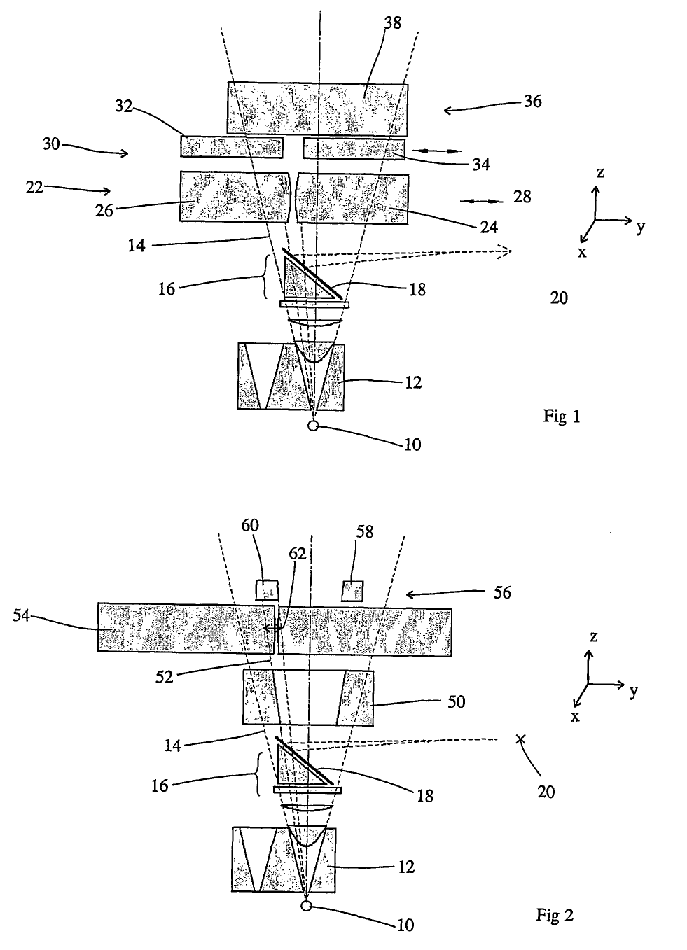

A multi-leaf collimator 54 is arranged after the aperture collimator 50. The maximum field of the MLC 54 is slightly less than the intermediate field size 52. As a result, the position of all leaves in the MLC array 54 can be seen by a camera at 20 via mirror 18, as in the known arrangement of FIG. 1. This provides an important re-assurance during operation that the apparatus is operating correctly.

Beyond the MLC 54, a leaf edge collimator 56 comprises two solid fixed bars 58, 60, aligned in the X direction and hence transverse to the leaves of the MLC 54. These are positioned so as to protrude into the intermediate field size 52 from the outside thereof by an amount which projects at the isocentre greater than the projected minimum approach of opposing leaf pairs of the MLC array 54. To provide room for usual positioning tolerances, in the example the bars are three times this minimum size. A ratio of two will often be adequate. Thus, when one leaf is fully withdrawn or nearly so and its opposing leaf is extended fully to the minimum approach, or nearly so, the gap 62 between them will be covered by the leaf edge collimator 56.

In this way, and in the ways set out above, moving X and Y collimators are obviated in favour of simple fixed collimators.

The leaf edge collimator is employed in the embodiment of FIG. 2 since the optical readout system employed to observe the position of the leaves of the MLC needs to have a clear line of sight to the ends of the leaves. In a system in which alternative readout systems are used, the closed leaves could be positioned above the aperture collimator and the leaf edge collimator would be unnnecessary.

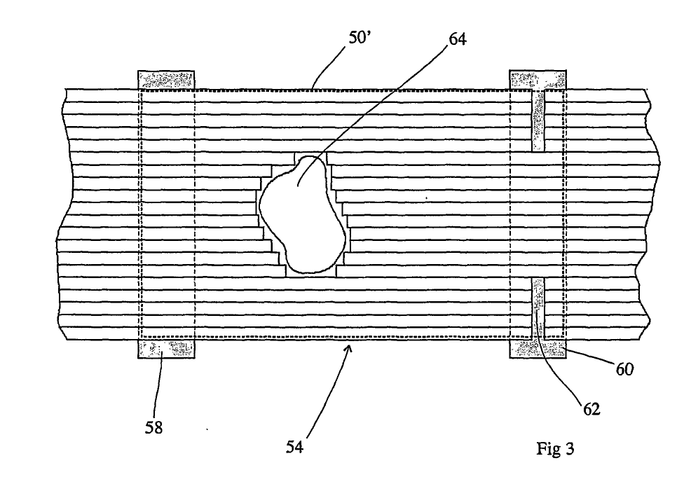

FIG. 3 shows for illustration the view of a camera at location 20 with the aperture collimator 50 removed. Dotted lines 50′ show the location of the aperture collimator 50. A tumour (for example) is located at 64 and the leaves of the MLC 54 are opened sufficient to allow a clear line of transmission to the tumour. Outside the field of the tumour, the leaves of the MLC 54 are extended or retracted as necessary such that their tips overlie the leaf edge collimator 60. Accordingly the gap 62 between opposing leaf tips is covered by the leaf edge collimator 60. The opposing leaf edge collimator 58 is redundant but offers flexibility in use as full leaf travel can be slow.

It will be appreciated by those skilled in the art that many variations can be made to the above described embodiment without departing from the present invention.

1. A collimator set for a radiotherapy apparatus comprising, in sequence, an aperture collimator and a multi-leaf collimator with a pair of opposing arrays of elongate leaves each moveable longitudinally in a Y direction, the aperture collimator being adapted to collimate the beam in the Y direction to an extent.

2. A collimator set according to claim 1 in which a leaf edge collimator is further provided, the leaf edge collimator being adapted to further collimate the extent of the beam in the Y direction to a second and therefore lesser extent.

3. A collimator set according to claim 1 or claim 2 in which the leaves of the multi-leaf collimator are focussed at a point offset relative to the target.

4. A collimator set according to any preceding claim in which the aperture collimator serves to collimate the beam in the X direction to an extent.

5. A collimator set according to any preceding claim in which the aperture collimator is fixed.

6. A collimator set according to any preceding claim, in which the leaf edge collimator is fixed.

7. A collimator set according to any preceding claim in which the projected difference in the Y direction between the first and second extent is not less than the projected minimum approach of opposing leaves of the MLC array.

8. A collimator set according to claim 7 in which the projected difference is more than twice the projected minimum approach.

9. A collimator set according to claim 7 in which the projected difference is more than three times the projected minimum approach.

10. A radiotherapy apparatus comprising a collimator set according to any preceding claim.

11. A collimator set substantially as herein described with reference to and/or as illustrated in the accompanying FIGS. 2 and 3.

12. A radiotherapy apparatus substantially as herein described with reference to and/or as illustrated in the accompanying FIGS. 2 and 3.
